(19) United States
(12) Patent Application Publication
(10) Pub. No.: US 2007/0156949 A1
(43) Pub. Date: Jul. 5, 2007

(54) Method and apparatus for single chip system boot

(76) Inventors: John C. Rudelic, Folsom, CA (US); Sean S. Eilert, Penryn, CA (US)

Correspondence Address: INTEL CORPORATION;c/o INTELLEVATE, LLC, P.O. BOX 52050, MINNEAPOLIS, MN, 55402, US

(21) Appl. No.: 11/322,674

(22) Filed: Dec. 30, 2005

(51) Int. Cl. G06F 12/00

(52) U.S. Cl. 711/103

(57) ABSTRACT

A method and apparatus for providing execution resources in a flash device is described herein. In a first mode, a write buffer in the flash device is used as a general purpose memory, i.e. a processing element, such as a host microprocessor uses the write buffer as an execution/variable space. In the first mode the write buffer is mapped as part of the flash address map, which is visible to the processing element for reading and writing. In a second mode, the write buffer acts as a buffer to write data into an array in the flash, as in normal operation. A selection/toggle module is used to select/toggle between the first and second modes. The selection or toggle may be based on commands, instructions, interrupts, user-initiated events, system-initiated events, or any combination thereof.

### FIELD

This invention relates to the field of memory devices and, in particular, to providing execution resources in a non-volatile memory device.

### BACKGROUND

Non-volatile memories, such as flash EPROM (erasable programmable read-only memory) devices have developed into a popular source of memory in a wide range of digital applications. Flash memory devices typically allow for high memory densities, high reliability, and low power consumption. These characteristics have made flash memory very popular for low power applications, such as embedded memory circuits. Common uses of non-volatile memory include portable computers, personal digital assistant (PDA) devices, digital cameras, cellular telephones, TV boxes, routers, copy machines, and any number of other consumer products. In these devices, both program code and system data, such as configuration parameters and other firmware, are often stored in flash memory, because of the compact storage and relative ease of software upgradeability.

Non-volatile memories are also often used in computer systems to store modular and upgradeable information, such as basic input/output software (BIOS), so pieces of the platform may be updated without having to frequently replace components in the system. Often, when booting a system, BIOS code is executed from a non-volatile memory to initialize the system. However, to execute the instructions and store data during initialization, system memory is typically started early in the boot process to provide a processor with execution resources, such as local variable storage. This early initiation potentially creates delay in the boot process and premature power consumption, which are both resources are at a premium in today's computer systems. Another resource at a premium in today's system includes the amount of system memory available at any time during the execution or initialization.

In the alternative, very complex actions to boot a system without enabling system memory have been attempted. One example includes using caches in a processor instead of a system memory. However, the performance of the system is potentially limited by execution of un-cached code in this implementation.

### BRIEF DESCRIPTION OF THE DRAWINGS

The present invention is illustrated by way of example and not intended to be limited by the figures of the accompanying drawings.

FIG. 1 illustrates an embodiment of a non-volatile memory including a main array, a buffer, and a toggle module.

FIG. 2 illustrates an embodiment of an address map in a non-volatile memory.

FIG. 3 illustrates an embodiment of a system including a processor coupled to a flash memory having a write buffer operable as a variable space.

FIG. 4 illustrates an embodiment of a flow diagram for providing a write buffer as a general purpose execution memory.

FIG. 5 illustrates an embodiment of a flow diagram for mapping a write buffer into an address space visible to a processing element.

### DETAILED DESCRIPTION

In the following description, numerous specific details are set forth such as examples of specific types of non-volatile memory, types of write buffers, functions of execution memory, etc. in order to provide a thorough understanding of the present invention. It will be apparent, however, to one skilled in the art that these specific details need not be employed to practice the present invention. In other instances, well known components or methods, such as instruction execution, execute in place (XIP) architecture, basic input/output software (BIOS), and other flash features have not been described in detail in order to avoid unnecessarily obscuring the present invention.

The method and apparatus described herein are for providing execution resources in a flash device. However, the methods and apparatus for providing execution resources are not so limited, as they may be implemented on or in association with any integrated circuit device, as well as any type of electronic system such as a PDA, a cell phone, a notebook, a desktop, a server, an embedded controller, or other device.

Non-Volatile Memory

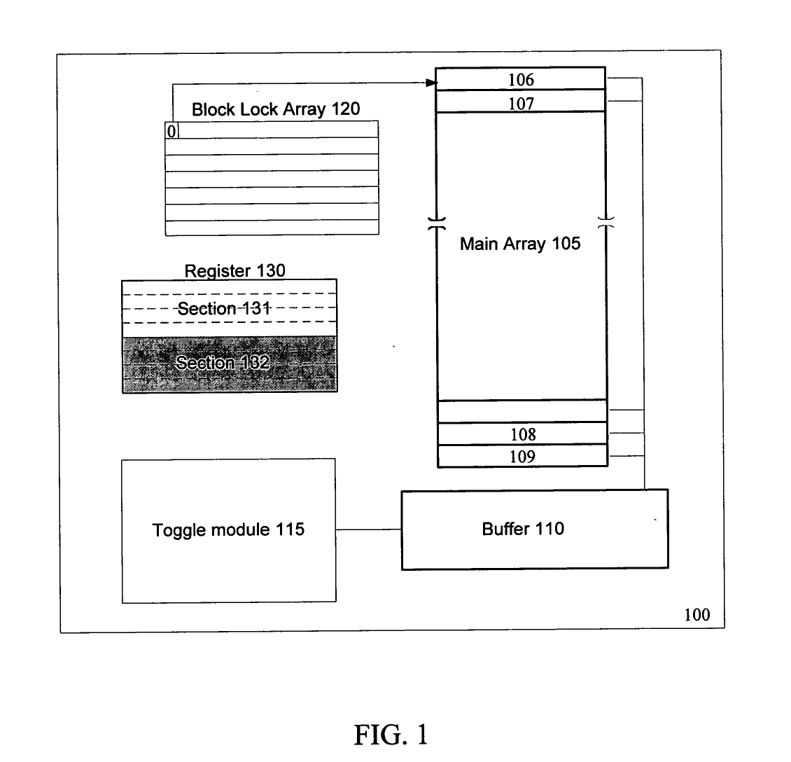

Referring to FIG. 1, an embodiment of a non-volatile memory device is illustrated. Non-volatile (NV) memory 100 is typically a memory that retains stored information after power is removed; however, NV memory 100 may be any memory including a memory array and buffer to write to the memory array. Memory device 100 may be a static random access memory (SRAM), a dynamic random access memory (DRAM), an electrically programmable read-only memory (EPROM), an electrically erasable programmable read only memory (EEPROM), a phase change memory or a flash device.

As a specific example, memory device 100 is an erasable programmable read-only memory (EPROM). An EPROM and an electrically erasable PROM, or EEPROM device, is often referred to as a flash device, since the device is “flashed” or electrically erased/programmed.

The two common types of flash memory include NOR and NAND flash memory, which refers to the types of transistors used in the device. Both types of flash memory store information in an array of transistors, which are referred to as cells. Traditionally, each cell stores 1-bit of information per cell; however, multi-bit or multi-level cells are also currently used to store multiple bits or logical levels per cell of a flash device.

Main Array, Blocks, Sectors, and Segments

A non-volatile memory device, such as device 100, typically includes an array, such as main array 105, to store the data, code, elements, logical values, and other information. Main array 105 may be physically or logically organized in any manner including a single dimensional array, a multiple dimensional array, or a plurality of random memory elements, as well as being physically partitioned or virtually partitioned to use different parts of one array for multiple uses or features.

In one embodiment, memory 100 is a flash device, where main array 105 is organized into blocks, segments, and/or sectors, such as blocks 106-109. Older implementations of flash devices required erasure of the whole flash device for programming. Since this was inefficient in frequently updated flash devices, a block organization became common to allow erasure on a block-level.

As an example, assume memory 100 is a NOR flash device. A NOR flash cell is typically set to a specified data value by starting up electrons flowing from the source to the drain and applying a large voltage placed on a control gate, which provides a strong enough electric field to accumulate the electrons on a floating gate, a process called hot-electron injection.

To erase a NOR flash cell, which is commonly done by resetting a cell to a logically high voltage, i.e. a 1 or high logic value, a large voltage differential is placed between the control gate and source, which pulls electrons off the floating gate. Most modern main memory arrays in flash devices are divided into erase segments, usually called either blocks, segments or sectors. Through operation of the erase procedure, a full block, segment or sector is erased. NOR programming, however, can generally be performed one byte or word at a time. NAND flash devices work on similar principles and are also often organized in sectors, segments or blocks. The specific implementations, operation, and manufacture of NOR and NAND flash is not described herein in detail to avoid obscuring the invention, as both types of flash are extremely well-known in the art.

Often, the use of logic levels or logical values is also referred to as 1's and 0's, which simply represents binary logic states. For example, a 1 refers to a high logic level and 0 refers to a low logic level. In many older systems a high voltage level was represented by a voltage, e.g. 5V, and a low voltage level, e.g. 0V. As another specific example, a high logic level is at 1.2V and a low logic level is at 0.3V. However, a high logic/voltage level may refer to any voltage level above a threshold value, and inversely, a low logic level may refer to any voltage level below the threshold value. In addition, there may be more than two logical levels in a cell or waveform. As an example, a single waveform may represent four different logical values at different voltage levels.

As stated above, main array 105 often stores elements, which includes data, data operands, instructions, information, or any combination thereof. In one embodiment, main array 105 stores elements in an execute in place (XIP) architecture.

An XIP architecture typically refers to the ability to execute code from referenced addresses without having to use and index or lookup table. Often, in and XIP architecture, virtual addresses are used to reference a location, such as in a paging or table lookup system. However, in an XIP architecture the elements are provided directly from the referenced address, as the physical to virtual address correlation usually does not change, even during compression of a storage window. For example, a physical address may be located at an exact offset from the virtual address or any portion, as well as the whole, of the virtual address may reference the physical address directly. It is apparent, that a virtual addressing system is not required, as direct physical addressing may be used.

The potential advantages of an XIP architecture are readily apparent, as there is no complex lookup logic or delay associated with translation of addresses. An XIP architecture is commonly used in booting a system, where blocks of a non-volatile memory are executed in-order and serially. The code is organized in the serial manner to allow the processor to step from block to block executing code and initializing the system, without introducing large amounts of delay and the complex logic discussed above.

Non-Volitle Memory Features

Non-volatile memory 100 may also include any other number of features. As shown in FIG. 1, memory 100 includes block lock array 120 and register 130. Block lock array 120 is typically used to lock blocks, such as blocks 106-109. Lock array 120 is used to lock blocks during erasure of other blocks or to lock blocks with vital information. As an example, block lock array 120 is a permanent lock array to permanently lock access to a block. Here, if a bit in lock array 120, which corresponds to block 106, is set to a first logical value, such as a zero, block 106 is permanently locked, i.e. able to be read by a user but not written to, erased, or reprogrammed. In another example, block lock array is a temporary locking array.

As an example of another feature, register 130 is illustrated having sections 131 and 132. Section 132 is present for a manufacturer to program information and then lock section 132 to lock access from customers and end-users. Section 131 provides similar functionality for a customer, as the customer programs information and is able to lock section 131 from end-users. Other features, such as a high voltage override module, or other commonly known feature of a non-volatile memory may be implemented in memory 100.

Write Buffer

Also illustrated in FIG. 1, is buffer 110. Buffer 110 includes any storage element, module, logic, circuits, or firmware in non-volatile memory 100 to buffer/store data, operands, instructions, or other elements.

In one embodiment, buffer 110 is a write buffer, which in normal operation, stores elements for, buffers elements for, and/or programs elements into array 105. In an example, write buffer 110 allows programming of multiple words simultaneously. Data is written to write buffer 110, then written into flash memory array 105. Using write buffer 110 with multiple word programming over single-word programming potentially vastly improves programming performance into main array 105. As a specific example, a write to write buffer 110 is made with a write-to-buffer command, which references a block to write to, such as block 106. Other bytes/words may also be written to write buffer 110 based on the write buffer's size and status/availability. Upon a read/write cycle, write buffer 110 writes/programs the words into main array 105 i.e. referenced block 106. As a specific example of buffer 110, buffer 110 is a multi-level cell (MLC) write buffer, which is able to store multiple logical values or bits per cell.

An example of using a write buffer in normal operation may be found in an article entitled, “Using the Intel StrataFlash® Memory Write Buffer,” which may be found at the following hyperlink: http://www.intel.com/design/flcomp/applnots/29222103.pdf, with the order number 292221-003 and dated September 2002.

Toggle/Selection Module

In FIG. 1, toggle module 115 is illustrated coupled to buffer 110. Toggle module 115 is to toggle buffer 110 between a buffer mode and an execution space mode. Toggle module 115 is also referred to herein as a selection module, as it selects between operational modes, such as general purpose memory mode and normal write buffer mode, of buffer 110. A module may be implemented in hardware, software, firmware, or any combination thereof. Commonly, module boundaries vary and functions are implemented together, as well as separately in different embodiments.

As an illustrative example, which is discussed in more detail below, a toggle module includes a software command to be issued to initiate the toggle of buffer 110 and a combination of firmware, software, and/or logic to map buffer 110 into the address space of main array 105 to accomplish a toggle of buffer 110 into a general purpose memory mode. As this example demonstrates, toggle module may transcend the boundaries of hardware, software, or firmware, as well as the boundaries of other functional modules in memory 100.

Toggling buffer 110 into an execution space mode may include any method of making buffer 110 accessible to a processing element, such as a host processor or embedded controller, for use as an execution space, i.e. an execution scratch pad. Essentially buffer 110 is used as a general purpose random access memory (RAM), i.e. an execution space, for emulation or actual variable space, local variable storage, register style storage, operand storage, or other style of operation commonly associated with using a RAM device.

In a first embodiment, toggling buffer 110 into an execution space mode includes reconfiguring buffer 110 to represent that buffer 110 is a separately addressable non-volatile memory array. Here, instructions executed from blocks stored in main array reference an address space/map associated with locations within buffer 110, which emulates a separately addressable NV array to be used by a processing element. In another embodiment, buffer 110 is toggled into a general purpose memory through use of a non-array entity/structure, such as a data-sheet database/common flash interface (CFI). More information on CFI may be found in the L18 datasheet, appendix C at the following link: ftp://download.intel.com/design/flcomp/datashts/25190210.pdf.

In yet another embodiment, toggling write buffer 110 includes associating buffer 110 with an address map/space of non-volatile memory 100. Examples of associating buffer 110 with an address map of non-volatile memory 100 include: (1) remapping an address space of buffer 110 as a floating window within the address space/map of main array 105 in NV memory 100; (2) extending an address space of or associated with an array in NV memory 100, such as array 105, to include an address space of or associated with buffer 110.

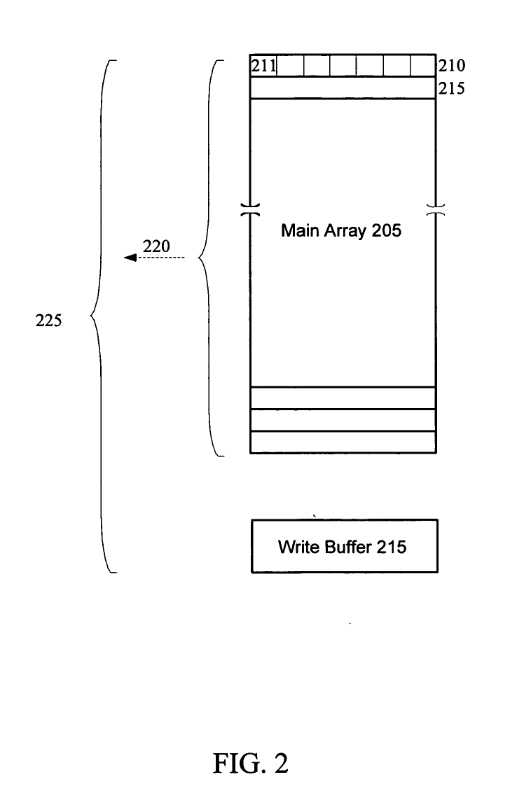

An embodiment of adding a buffer to an address map of a main array in a flash memory is illustrated in FIG. 2. Abstractly, FIG. 2 illustrates an initial address map 220 of main array 205. Typically a processing element, will execute code from blocks of main array 205, such as block 211. Main array 205, may also be organized in sectors, such as sectors 210 and 212. A processing element, when executing an instruction or accessing main array 205 references either a physical or virtual address associated with main array 205. As a specific example, in normal operation, a processing element will initiate a write referencing block 211 in array 205. The information is written to write buffer 215, and upon a write cycle, write buffer 215 writes the information to block 211. However, when write buffer 215 is in normal operation mode, an address space associated with write buffer 215 is typically not accessible by a processing element as an execution space.

However, as shown in FIG. 2, an address space of main array 205 is extended or remapped to include write buffer 215, which is shown in address map 225. As a result, a processing element may access write buffer 215 as a general purpose memory/execution space. As one example, a lookup table associating virtual addresses with physical addresses in updated/toggled to include an address range of virtual addresses referencing physical addresses associated with write buffer 215. Note that an address space of write buffer 215 may be a floating window that appears anywhere in the address map of a non-volatile memory device. As shown, write buffer 215 appears at the end of the address map of the non-volatile memory in address map 225, but it may appear at the beginning, end or anywhere within the address map.

Returning to FIG. 1, toggle module 115 is also to toggle buffer 110 back into or initially into a write buffer mode or normal operation mode. In this case, write buffer 110 is typically not accessible as an execution scratch pad or general purpose memory during execution by a processing element. However, as stated above, in normal operation, write buffer 110 is accessed by write operations to array 105, which may be initiated by a processing element upon execution of an instruction. Write buffer 110's normal operation is discussed in more detail above in the write buffer section.

Toggle module may toggle buffer 110 based on system generated commands/interrupts, user commands/instructions, and/or other commands, instructions, or events. For example, assume that by default, memory 100 is a flash memory storing basic input/output software (BIOS), and when flash memory 100 boots up, write buffer 110 is in a general purpose memory mode. In this case, any number of events may trigger toggle module 115 to select a write buffer mode for write buffer 110 including: (1) a user command, (2) a system generated interrupt, (3) an event such as completing initialization of a system and handing off control to an operating system, (4) a system generated command, (5) an instruction stored in main array 105 to be executed before, during or upon exiting an initialization routine.

Note that reference to a default state for buffer 110 was mentioned, where buffer 110 was initialized as a general purpose memory visible in the address map of non-volatile memory 100. Alternatively, buffer 110's default state is a normal operational write buffer mode. In addition, the potential advantages of operating buffer 110 as a general purpose memory have been discussed during boot of a system. Yet, an optional command, instruction, or event may also toggle buffer 110 to a general purpose memory mode during runtime or when another application or operating system has control of the system.

In one example, assume a system is booted including non-volatile memory 100, an operating system is executing, and a processing element is present in non-volatile memory 100 in addition to an external host-processor. Further assume that some event requires code in main array 105 to be executed by the processing element in non-volatile memory 100, such as a microcontroller, or the host processor. Instead of using a system memory as execution space, write buffer 110 is toggled to a general purpose memory mode. Execution, including using buffer 110 as local variable storage or emulated register storage, is completed. Then write buffer 110 is toggled back into a write mode. Note that a user command/instruction, a triggering event, an interrupt, or other system signal may initiate the toggle of buffer 110 through toggle module 115 in the previous example.

### An Embodiment of a System

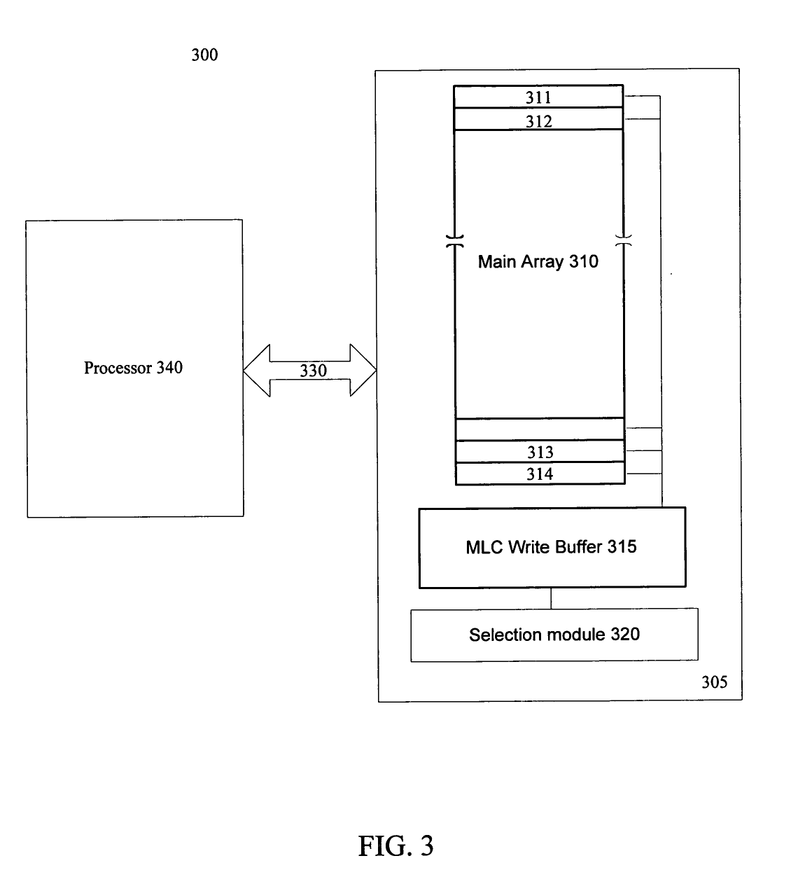

Turning over to FIG. 3, a non-volatile (NV) memory 305 is illustrated coupled to processing element 340. Processing element 340 is any execution resources for executing code/instructions or for operating on data. Although, processor 340 is illustrated external to and electrically coupled to memory device 305, memory device 305 may include processor 340 or in combination with processor 340 include another microcontroller, embedded processor, firmware, or other execution resources. In fact, it is common to include an embedded controller or microcontroller in an NV memory or flash memory, such as NV memory 305.

In one embodiment, processor 340 is a host microprocessor capable of parallel execution. Processor 340 may also be capable of out-of-order (OOO) execution, integer execution, floating point execution, speculative execution, transactional execution, branch prediction, or other common microprocessor or microcontroller functions. Other common examples of processing elements include cell processors, host processors, microprocessors, microcontrollers, embedded controllers, Application Specific Integrated Circuits (ASICs), Field Programmable Gate Arrays (FPGAs), a digital signal processor, a video processor, a network processor, and other electronic devices that execute instructions or operate on data.

Processor 340 is coupled to non-volatile memory 305 through interconnect 330, which is any electrical, optical, or other connector between two devices. Although not shown, other devices, such as controller hubs, may be present between processor 340 and non-volatile memory 305. In a specific embodiment, processor 340 is coupled to a memory controller hub. The memory controller hub is coupled to an interconnect controller hub, which is in turn, coupled to non-volatile memory 305. Other common system arrangements may be used as well.

Non-volatile memory 305 is referenced, for the duration of the discussion of FIG. 3, as flash 305 to simplify the illustrative embodiment. Flash 305 includes a main array 310 having a plurality of memory segments, such as segments 311-314. Segments 311-314 are to store a plurality of elements, such as code, words, bits, bytes, instructions, commands, data, data operands, or any combination thereof. Flash 305 also includes multi-level cell (MLC) write buffer 315.

In a first operation mode, MLC write buffer 315 is to operate as a variable space. In this operational mode, MLC write buffer 315 is visible to processor 340 in an address map of flash 305. As stated above, MLC write buffer 315 may be visible as part of main array 310's address map. In one embodiment, an address map of MLC write buffer 315 is extended into the address map for main array 310. Another way of stating this is: an address map of main array 310, visible to processor 340, is extended to include MLC write buffer 315. Note that MLC write buffer 315 may be visible at the beginning of the address map, appended to the end of the address map, or a floating window within the address space.

In a second mode, MLC write buffer 315 operates as a write buffer to buffer writes to segment 311-312, as well as other segments of main array 310. Normal operation of MLC write buffer 315 is discussed above. Typically, write buffer 315, in the second mode, is not visible as general purpose memory to processor 340. However, processor 340 still accesses MLC write buffer 315 to write into main array 310, as processor 340 would in normal write buffer operation.

Selection module 320 is illustrated coupled to MLC write buffer 315. However, selection module 320 may be implemented in hardware, software, firmware, or any combination thereof. Selection module 320 is to select the first mode of operation of MLC write buffer 315 based on a first command, such as an enter general purpose memory mode, i.e. first mode, command. Selection module 320 is also to select the second mode, i.e. a normal operation mode, based on a second command, such as an enter write buffer mode command.

In one example, selection module includes one bit. If the bit has a first value, MLC write buffer 315 is put in the first mode. As discussed above, this is accomplished, in one embodiment, by placing MLC write buffer 315 in address space that processor 340 is able to write to and read from. In another example, selection module includes a handler to handle an interrupt generated based on the first or second command. The handler is to execute a routine to place the MLC write buffer 315 into a general purpose execution mode, if an enter general purpose execution mode command/interrupt was issued/generated. Inversely, the handler places write buffer 315 in a normal operation mode, if the second command was issued.

Other examples and equivalents may also be incorporated in selection module 320, which include components of other functional blocks/modules. For example, selection module 320 includes a first command to be executed by processor 340 to access and execute block 311 in main array 310. Block 311 includes code, that when executed, places MLC write buffer 315 in a general purpose memory mode. Conversely, execution of an instruction/command referencing segment 312 puts write buffer 315 in normal operation mode. Even more examples, such as issuing a command, to be executed by processor 340 or a microcontroller not shown in flash 305, selects modes directly.

In normal operation, processor 340 is to write to main array 310 using MLC write buffer 315, as discussed above. In contrast, in a general purpose memory mode, processor 340 uses write buffer 315 as a general purpose random access memory (RAM) like device, i.e. for execution operations, storage, and/or variable space. Although, MLC write buffer 315 may have a different structure than a RAM device, such as a latch structure, the basic operations of being able to store in and read from MLC write-buffer allow processor 340 to use it as a general purpose memory.

As noted above, in a first embodiment, the default state of MLC write buffer 315, upon boot, is a general purpose memory mode to aide in initializing system 300 without having to initialize a system memory. Alternatively, the default state of MLC write buffer 315 is a normal operation mode and a general purpose mode is selected by selection module 320 based on a command.

### An Embodiment of a Method for Providing General Purpose Memory

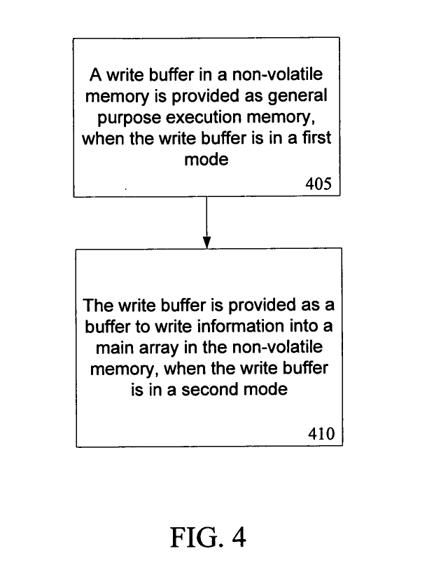

Turning next to FIG. 4, an embodiment of a flow diagram for providing a write buffer in a non-volatile (NV) memory as general purpose execution memory is illustrated. In flow 405, a write buffer in a NV memory is provided as a general purpose execution memory, when the write buffer is in a first mode. The write buffer may include a single cell write buffer or a multi-level cell write buffer.

In one embodiment, providing a write buffer in a NV memory as a general purpose execution memory includes remapping an address space of the write buffer into an address space accessible by a processing element for execution operations, such as execution instructions, storing data, storing local variables, manipulating variables, and operating on data. Here, remapping includes any association of write buffer in an address space or address map that a processing element, which is either external or internal to the NV memory, is able to read from and write to. An example is providing the write buffer as part of an address map of a main array. As stated above, other examples include emulating the write buffer as a separately accessible NV array or extension of a tent address space to include the write buffer.

Next, in flow 410, the write buffer is provided as a buffer to write information into a main array in the non-volatile memory, when the write buffer is in a second mode. Providing a write buffer as a buffer to write information includes enabling the write buffer to operate normally. Often this includes, not allowing the processing element access to the write buffer as general purpose memory, but it is not so limited.

### An Embodiment of a Method for Mapping a Write Buffer into a Visible Address Space

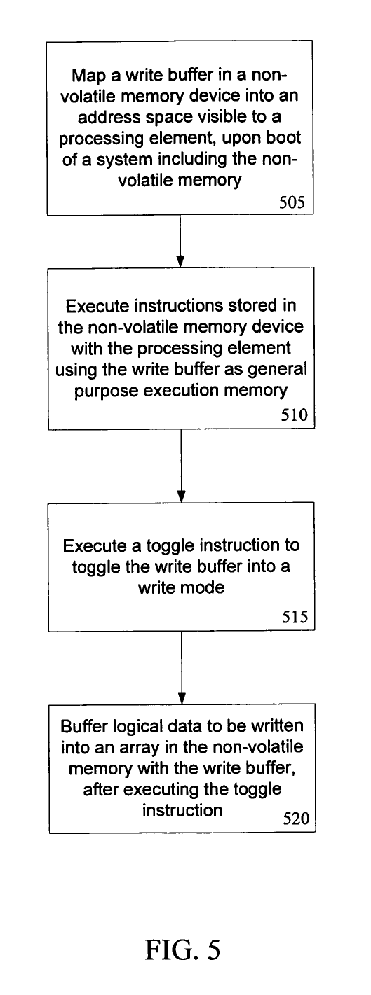

Referring last to FIG. 5, an embodiment of a flow diagram for mapping a write-buffer into a visible address space is illustrated. In flow 505, a write buffer in a NV memory device is mapped into an address space visible to a processing element, upon boot of a system including the NV memory. An example of mapping includes associating an address space of the write buffer, which is a virtual address space or physical address space, with a physical or virtual address space of the main array in the NV memory. Essentially, from the processing element's perspective, the write buffer has now become a part of the NV main array that it is able to read from, as well as write to.

Although, semantically the processor writes to a write buffer in normal operation, since the write buffer is to buffer writes to the main array, the processor is referencing a block in the NV main array to write the logical information to. In contrast, when the write buffer is “visible” to the processing element, the processing element is writing a local variable or other element to the write buffer itself, instead of to a location to be written to by the write buffer. Furthermore, the processing element is able to read out of the buffer a stored variable to operate on.

Therefore, in flow 510, instructions stored in the NV memory device are executed with the processing element using the write buffer as general purpose execution memory. As an example, upon boot, an instruction is executed by the processor to initiate a power on self test (POST) or other initialization function. Assume that the instruction requires the processing element to read four data operands from main NV memory and then add the first with the second operand and the third with the fourth, as well as the result of both of those add operations. The processing element adds the first and second operands, stores the temporary result in the write buffer, adds the third and the fourth operands, and then reads the temporary result from the write buffer, and adds the results.

In flow, 515 a toggle instruction is executed to toggle the write buffer into a write mode. Here, the write buffer operates as a normal write buffer. This toggle instruction/command may be executed/issued during boot or upon exit. Continuing the example above, the write buffer is toggled into a write buffer mode and the final result is written into the main NV array. Also, upon exiting a boot/initialization sequence, the toggle instruction, i.e. a command, may be executed to return the buffer to a write mode during runtime operation of a system.

During normal operation, in flow 520, logical data to be written into an array in the NV memory is buffered with the write buffer, after executing the toggle instruction. This refers to the normal operating of buffering data to be written to the NV main memory array with the write buffer.

The embodiments of methods, software, firmware or code set forth above may be implemented via instructions or code stored on a machine-accessible or machine readable medium which are executable by a processing element. A machine-accessible/readable medium includes any mechanism that provides (i.e., stores and/or transmits) information in a form readable by a machine, such as a computer or electronic system. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

As illustrated above, a write buffer is potentially used in multiple modes to provide functionality and save power. Typically, upon initialization of a system it is costs power and time to initialize a system memory early within the initialization process. In addition, emulation of system memory with other memories, such as cache memories on a processor, are complex and create long delays for operation on data or execution of instructions that is not previously cache. Consequently, by adding a write buffer in an NV memory to an accessible, visible, or addressable address map of the NV memory, the processor is able to use the write buffer as a general purpose memory to perform execution operations. In addition, memory in a system is always at a premium; therefore, during runtime an optional command/instruction may also select/toggle to a general purpose memory mode to provide additional execution/variable space.

In the foregoing specification, a detailed description has been given with reference to specific exemplary embodiment. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus comprising:
a non-volatile memory device including,
a main array logically organized in blocks;
a buffer coupled to the main array to write logical data into the blocks; and
a toggle module to toggle the buffer into a general purpose memory mode.

2. The apparatus of claim 1, wherein the non-volatile memory device is selected from a group consisting of a NOR flash memory, a NAND flash memory, or a phase change memory device.

3. The apparatus of claim 1, wherein the main array is to store instructions and operands.

4. The apparatus of claim 3, wherein the main array is to store instructions and operands in an execute in place (XIP) architecture.

5. The apparatus of claim 1, wherein buffer is a write buffer.

6. The apparatus of claim 5, wherein the write buffer is a multi-level cell (MLC) write buffer.

7. The apparatus of claim 6, wherein the toggle module is to toggle the MLC write buffer into the general purpose memory mode based on a first command.

8. The apparatus of claim 7, wherein the toggle module is also to toggle the MLC write buffer into a write buffer, not accessible as a general purpose memory mode, based on a second command.

9. The apparatus of claim 1, wherein toggling the buffer into a general purpose memory mode comprises remapping the buffer into an address map of the non-volatile memory to allow a processing element to use the buffer as general purpose memory.

10. The apparatus of claim 1, wherein using the buffer as general purpose memory comprises storing local variables in the buffer during execution operations.

11. An apparatus comprising:
a flash memory including,
a main array to store a plurality of elements;
a multi-level cell (MLC) write buffer to operate in an execution space mode, upon boot of a system; and
a toggle module to toggle the MLC write buffer into a normal write buffer mode, upon execution of a first instruction.

12. The apparatus of claim 11, wherein the flash memory is a NOR flash memory.

13. The apparatus of claim 11, wherein the plurality of elements include a plurality of instructions and a plurality of data operands.

14. The apparatus of claim 13, wherein the plurality of instructions are organized in an execute in place (XIP) architecture.

15. The apparatus of claim 14, wherein the execution space mode includes a mode where a processor executing the plurality of instructions in an XIP architecture utilizes the MLC buffer as an execution scratch pad.

16. The apparatus of claim 15, wherein the normal write buffer mode includes a mode where writes to the main array are buffered through the MLC buffer and the MLC buffer is not accessible as an execution scratch pad to the processor.

17. The apparatus of claim 11, wherein the first instruction is executed upon completing the boot of the system.

18. A system comprising:
a non-volatile memory device including
a main memory array having a plurality of memory segments to store a plurality of elements;
a multi-level cell (MLC) write buffer to operate as a variable space in a first mode, and
to operate as a write buffer to buffer writes to the plurality of segments in the main memory array in a second mode, and
a selection module to select the first mode based on a first command and to select the second mode based a second command;
a processor coupled to the memory device to perform execution operations on elements stored in the main memory array using the MLC write buffer as the variable space, when the MLC write buffer is in the first mode.

19. The system of claim 18, wherein the plurality of elements include a plurality of instructions and a plurality of operands.

20. The system of claim 18, wherein a default mode of the MLC write buffer is the first mode.

21. The system of claim 18, wherein a default mode of the MLC write buffer is the second mode.

22. The system of claim 18, wherein where selecting a first mode based on a first command comprises extending an address space associated with the MLC write buffer into an address space of the non-volatile memory to be used by the processor as the variable space upon execution of the first command, and wherein selecting a second mode based on a second command comprises removing the address space associated with the MLC write buffer from the address space of the non-volatile memory to be used by the processor as the variable space upon execution of the second command.

23. The system of claim 18, wherein the processor is a host microprocessor.

24. A method comprising:
providing a write buffer in a non-volatile memory as general purpose execution memory, when the write buffer is in a first mode; and
providing the write buffer as a buffer to write information into a main array in the non-volatile memory, when the write buffer is in a second mode.

25. The method of claim 24, wherein providing a write buffer in a non-volatile memory as general purpose execution memory comprises: remapping an address space of the write buffer into an address space accessible by a processing element for execution operations.

26. The method of claim 25, wherein the write buffer is a multi-level cell write buffer.

27. The method of claim 26, wherein the non-volatile memory is a flash memory, and where the main array is to store at least instructions to be executed in an execute in place (XIP) architecture by the processing element.

28. The method of claim 26, wherein execution operations include executing the instructions.

29. The method of claim 24, wherein the first and second mode of the MLC write buffer is toggled between based on execution of an instruction.

30. A method comprising:
mapping a write buffer in a non-volatile memory device into an address space visible to a processing element, upon boot of a system including the non-volatile memory; and
executing instructions stored in the non-volatile memory device with the processing element using the write buffer as general purpose execution memory;
executing a toggle instruction to toggle the write buffer into a write mode; and
buffering logical data to be written into an array in the non-volatile memory with the write buffer, after executing the toggle instruction.

31. The method of claim 30, wherein mapping a write buffer into an address space visible to a processing element comprises associating an address space of the write buffer with an address space of the main array in non-volatile memory to allow the processing element to access the write buffer as general purpose execution memory.

32. The method of claim 30, wherein executing instructions with the processing element stored in the non-volatile memory device using the write buffer as general purpose execution memory comprises executing instructions in the non-volatile memory using the write buffer to store variables.

33. The method of claim 30, wherein the toggle instruction is an instruction stored in the main array in the non-volatile memory to be executed upon exit of a boot sequence.

34. The method of claim 30, wherein the write buffer is a multi-level cell (MLC) write buffer, and wherein the non-volatile memory is selected from a group consisting of a NOR flash memory, a NAND flash memory, and a phase change memory.

35. An article of manufacture including program code which, when executed by a machine, causes the machine to perform the operations of:
placing a write buffer in an address map of a flash array, upon execution of a first instruction; and
placing the write buffer in a normal operation mode to buffer writes into the flash array of the flash memory device, upon execution of a second instruction.

36. The method of claim 35, wherein placing a write buffer in an address map of a flash array comprises associating virtual addresses referencing the write array with virtual addresses referencing the flash array.

37. The method of claim 35, wherein associating virtual addresses referencing the write array with virtual addresses referencing the flash array comprises extending the address map including the virtual addresses referencing the flash array to include the virtual addresses referencing the write buffer.

38. The method of claim 36, wherein placing the write buffer in a normal operation mode comprises deassociating virtual addresses referencing the write array with virtual addresses referencing the flash array.
